(19) United States
(12) Patent Application Publication
(10) Pub. No.: US 2008/0042309 A1
(43) Pub. Date: Feb. 21, 2008

(54) Lyocell Method and Device Comprising a Press Water Recirculation System

(75) Inventors: Stefan Zikeli, Regau (AT); Werner Schumann, Bad Blankenburg (DE); Lutz Glaser, Rudolstadt (DE); Michael Longin, Vocklabruck (AT)

Correspondence Address: MICHAEL BEST & FRIEDRICH LLP, 100 E WISCONSIN AVENUE, Suite 3300, MILWAUKEE, WI, 53202, US

(73) Assignee: ZIMMER AKTIENGESELLSCHAFT, Frankfurt am Main (DE)

(21) Appl. No.: 11/569,058

(22) PCT Filed: Feb. 28, 2005
(86) PCT No.: PCT/EP05/02097

§ 371 Date: Jan. 23, 2007

(30) Foreign Application Priority Data
May 13, 2004 (DE) 10 2004 024 028.0

(51) Int. Cl. B29C 45/76; D01F 2/02

(52) U.S. Cl. 264/40.1; 264/211; 425/135

(57) ABSTRACT

The invention relates to a method and a device (1) for the production of a cellulose solution, from which endless moulded bodies (2) can be extruded. First, a cellulose suspension is produced from cellulose (3, 4) and water (6) in a pulper (5). The cellulose suspension is then expressed by a press device (10). After expressing, a tertiary amine oxide, in particular N-methylmorpholine-N-oxide, is fed as a solvent to the cellulose suspension, thus producing a cellulose solution. The efficiency of the method and the device and their environmental compatibility can be improved in that the press water (11) expressed by the press device (10) is at least in part fed back to the pulper (5). In a further development the proportion of the press water (15) in the water (6) is varied depending on the metal content of the cellulose (3, 4) and/or of the cellulose solution.

The invention relates to a method for the production of a cellulose solution, from which endless moulded bodies can be extruded, wherein according to the method first a cellulose suspension is produced from cellulose and water, the said suspension being expressed with the production of press water, and then the cellulose solution is produced from the cellulose suspension by the addition of tertiary amine oxide, and wherein the press water is fed back for treating or disintegrating the cellulose.

The invention also relates to a device for the production of a cellulose solution, from which solution endless moulded bodies can be extruded, with a pulper, in which during operation cellulose and water can be admixed to a cellulose suspension, with a press device, through which during operation the cellulose suspension can be expressed with the generation of press water, and with a mixer, through which during operation tertiary amine oxide can be added to the cellulose suspension to produce the cellulose solution.

This type of method and this type of device are known for example from the Lyocell technology, in which threads, fibres, foils and membranes are extruded as endless moulded bodies from a cellulose solution containing cellulose, water and tertiary amine oxide. On account of its environmental friendliness, the Lyocell technology is increasingly replacing the conventional viscose methods. The environmental friendliness of the Lyocell method results from the solution of the cellulose without derivatisation in an organic, aqueous solvent. From this cellulose solution endless moulded bodies, for example fibres and foils, are then extruded. Due to the production of the moulded bodies and the orientation and regeneration of the cellulose occurring in the course of the extrusion, moulded bodies of high strength are obtained with numerous applications in the textile and non-textile sectors. The name “Lyocell” was issued by the BISFA (International Bureau for the Standardisation of Man-made Fibres). In the state of the art the Lyocell method is now well documented.

From U.S. Pat. No. 2,179,181, tertiary amine oxides are known as solvents for cellulose which can dissolve cellulose without derivatisation. From these solutions the cellulose moulded bodies can be obtained by precipitation.

The processing of the cellulose, dissolved in an aqueous amine oxide, particularly N-methylmorpholine-N-oxide (NMMNO), is however problematical with regard to safety, because the degree of polymerisation of the cellulose decreases when dissolving the cellulose in NMMNO. In addition, amine oxides generally exhibit only a limited thermal stability, particularly in the system NMMNO/cellulose/water, and show a tendency to spontaneous exothermic reactions. To overcome these problems and to be able to produce Lyocell fibres economically, there is a series of approaches for a solution in the state of the art.

In U.S. Pat. No. 4,144,080, it is stated that at high temperatures the cellulose dissolves more quickly in a tertiary amine-N-oxide and forms a more homogeneous solution if the cellulose is milled together with the preferred ingredients of tertiary amine-N-oxide and water. In WO-94/28219, a method for the production of a cellulose solution is described in which milled cellulose and an amine oxide solution are placed into a horizontal, cylindrical mixing chamber. The mixing chamber shows axially spaced stirring elements that rotate around the longitudinal axis of the mixing chamber. Apart from NMMNO, N-methylpiperidine-N-oxide, N-methylpyrrolidone oxide, dimethylcyclohexylamine oxide and others can be used as the amine oxide. Mixing in the mixing chamber occurs between 65° C. and 85° C. According to WO-A-98/005702, the cellulose is mixed in a device with the aqueous solution of the tertiary amine oxide, whereby the mixing device exhibits a mixing tool and a container which rotates during the mixing.

In WO-A-98/005702, the mixing tool is improved such that it is formed as a paddle, rail or helix and preferably prevents the formation of deposits on the inner surface of the container during mixing. In WO-A-96/33934, a buffer device is described, which comprises a mixing vessel and a conveyor worm as a discharging device. In this way a continuous production of the cellulose solution is possible despite the cellulose being fed in batches.

The method of WO-A-96/33934 has been improved by the method of WO-96/33221, in which a homogeneous cellulose suspension is produced from milled cellulose and an aqueous amine oxide solution in one single step. For this purpose, the milled cellulose is brought into contact with the liquid, aqueous tertiary amine oxide and a first mixture is formed. The first mixture is spread in layers on a surface and transported under intensive mixing over this surface. This process can be carried out continuously. Other methods in which the cellulose solution is treated in the form of a thin layer are also known from EP-A-0356419, DE-A-2011493 and WO-A-94/06530.

Also the milling of the cellulose itself is an object of the patent publications. For example, U.S. Pat. No. 4,416,698 mentions it as an advantage if the cellulose is milled to a particle size of less than 0.5 mm. In WO-A-95/11261, predisintegrated cellulose is fed into an aqueous solution of a tertiary amine oxide to produce a first suspension. This first suspension is then milled and converted into a formable cellulose solution with the application of heat and a reduced pressure. In order to feed the dust, arising from milling or disintegrating the cellulose, back into the process, filters are used in WO-A-94/28215 through which the cellulose dust is separated from the air. In WO-A-96/38625, a system is described which can disintegrate both cellulose bales as well as cellulose in leaf form. A medium chute is provided which opens into a device for prepulverising the cellulose.

In EP-B-0818469, it is suggested that cellulose is dispersed in aqueous amine oxide solutions and the dispersion thus obtained treated with xylanases.

Apart from these efforts to economically produce a homogeneous cellulose solution capable of being spun, there are also attempts to overcome the problem of the decomposition phenomena of the cellulose solution occurring spontaneously due to an exothermic reaction. In Buijtenhuis et al. The Degradation and Stabilisation of Cellulose Dissolved in NMMNO, in: Papier 40 (1986) 12, 615-618, test results are described, according to which metals in the cellulose solution appear to reduce the decomposition temperatures of the NMMNO. Primarily, iron and copper appear to promote the decomposition of NMMNO. Other metals, such as for example nickel or chrome, in appropriate quantities and appropriate concentration also exert a negative influence on the decomposition properties of the cellulose solution if they are present in appropriate concentrations. However, in WO-A-94/28210, stainless steel is still used as the material for a spinning head in order to withstand the high pressures during the extrusion of the cellulose solution.

In addition, in the highly concentrated NMMNO region, the system NMMNO/cellulose/water has the property of releasing metal ions from the process apparatus, such as pipings, filters and pumps, which reduces the system stability. In WO-A-96/27035, a method for the production of cellulose moulded bodies is described in which at least some of the materials in contact with the cellulose solution contain at least 90% of an element from the group of titanium, zirconium, chrome and nickel down to a depth of at least 0.5 μm. The important aspect with regard to WO-A-96/27035 is that the rest of the composition of the apparatus and piping, where it comes into contact with the cellulose solution, does not contain any copper, molybdenum, tungsten or cobalt. According to WO-A-96/27035, this measure shall prevent exothermic decomposition reactions.

Finally, in DE-C-198 37 210, which is taken as the closest state of the art, a homogeneous cellulose solution is produced irrespective of the water content of the cellulose used. In contrast to current methods, here, the cellulose is first transported in the absence of NMMNO under homogenisation in a pulper through an initial shear zone and is only then added to a low water-content NMMNO.

Another way of producing the cellulose solution is followed in DE-A-44 39 149, which forms the closest state of the art. According to the method of DE-A-44 39 149, the cellulose is pretreated enzymatically. To increase the effectiveness of the enzymatic pretreatment, the cellulose can be treated before the pretreatment by shearing action in water. Then, the pretreated cellulose is separated from the liquor and the separated cellulose is fed into a melt of NMMNO and water. Practicably, the separated liquor can be returned to the pretreatment after supplementing the loss of water and enzyme. However, in practice, this type of process management has been found to be impracticable, because the cellulose solution obtained in this way is unstable.

Despite these various approaches for trying to obtain a homogeneous and stable cellulose solution and to convey it to the extrusion openings while avoiding exothermic decomposition reactions, the environmental friendly and economical production of a homogeneous cellulose solution and the stability of the cellulose solution remain problematic.

The object of the invention is therefore to provide a stable and homogeneous cellulose solution for the Lyocell method which is produced environmentally compatible and economically.

This object is solved for the aforementioned method in that fresh water is additionally mixed with the fed back press water and the proportions of press water and fresh water are varied depending on the cellulose.

For the device referred to in the beginning, this object is solved according to the invention in that a press water pipe, through which during operation at least part of the press water can be fed back from the press device to the pulper, and a mixing device, through which the proportion of the press water in the water fed back to the pulper can be variably adjusted, are provided.

The solution according to the invention is surprising, because although the NMMNO cellulose/water system is at first glance destabilised due to the press water feedback on account of the metal ions contained in the press water, as experiments show, the system settles to a stable value by admixing the fed back press water to fresh water. Overall, the environmental compatibility and the efficiency of the method are decisively improved by the press water feedback.

In order to consider the different types of cellulose during mixing, which with their respectively different cellulose content and ingredients affect the stability of the cellulose solution, the proportions of press water and fresh water fed to the pulper can be changed. The feeding of fresh water avoids that substances, which are contained in the cellulose and expressed with the press water, become enriched in large amounts in the suspension, and then lead to an instability of the cellulose suspension or cellulose solution. In particular, this measure can prevent the content of metal ions, which can result in an exothermic reaction of the cellulose solution to which tertiary amine oxide has been added, to rise beyond critical values. The fresh water fed anew to the pulper in the circulation can be partially or completely desalinated. Overall, the method is economically and environmentally improved due to the reused press water.

The solution according to the invention enables the use of any types of cellulose for the production of Lyocell fibres, thus making the method significantly more versatile.

The method according to the invention and the device according to the invention can be further improved in a series of advantageous further developments which can be combined with one another.

For example, it is particularly advantageous if the proportion of the water additionally added in the section of the pulper is varied depending on the metal content of the cellulose. The total water added to the pulper for disintegrating the cellulose can, according to an advantageous embodiment, contain between 50% and 100% of press water. By changing the water mixture, a high environmental compatibility of the method can be achieved while maintaining system stability, because part of the press water always remains in the system and is not released to the environment. At the same time, the stability of the suspension is set to safe values by controlling the composition of the water in the pulper. Since the metal ion content, in particular the iron ions (Fe³⁺), the copper ions (Cu²⁺) and the molybdenum ion content, varies substantially for different types of cellulose, a variety of the most different types of cellulose can be processed without increasing the risk of an exothermic reaction due to the adjustment of the water composition.

By changing the fresh water content and/or the press water content in the water used for disintegration of the cellulose in the pulper, the metal content of the cellulose solution can be adjusted to below 20 mg/kg regardless of the type of cellulose used, according to an advantageous further development. Advantageously, the proportions of the fresh water and/or of the press water are set such that the metal content of the cellulose solution is adjusted to below 10 mg/kg, but more preferably to below 5 mg/kg. Using these values, very good stability values can be achieved with a very low risk of exothermic reactions, after the addition of tertiary amine oxide to the cellulose solution.

The proportions of fresh water and press water can be varied via a mixing device. The mixing device can, in this respect, be controlled by a control device such that the metal content or the content of certain metal ions in the cellulose solution or in the cellulose suspension is adjusted under closed-loop control to a predetermined value or range. As mentioned above, the situation is achieved where, despite the production of the solution running with a high amine oxide concentration and the resulting higher dissolving power of the NMMNO for metal ions from metallic apparatus, the basic content of metal ions is reduced before the production of the solution.

In order to be able to determine the metal content of the cellulose solution or the composition of the water fed to the pulper for treating the cellulose accurately, it is advantageous if the content of the metal ions in the cellulose suspension and/or in the cellulose solution is monitored, for example, by suitable sensors.

The spectrum of the processable celluloses can also be improved by initially producing the suspension essentially without adding a solvent, tertiary amine oxide, such as NMMNO. Cellulose suspensions with almost the same composition can be processed via control of the proportions of cellulose and water in the suspension.

The stability of the cellulose solution can, according to a further advantageous embodiment, be increased by the addition of metal-binding additives, for example to the water in which the cellulose is disintegrated. The metal-binding additives reduce the tendency of a cellulose solution containing tertiary amine oxide to produce spontaneous exothermic reactions. Complexing agents or stabilisers in the alkali or acidic range can, for example, be considered as metal-binding additives.

The press water recirculated to the pulper can be filtered before disintegration of the cellulose to filter out residues, particles and ion products, in particular metal ion products. The returned press water can also be osmotically treated before or after the treatment of the cellulose, but in any case before further use. Other filtration techniques and methods comprise surface filters, deep-bed filters, membrane filters, plate filters, edge filters, separators, centrifuges, hydrocyclones, belt filters and vacuum belt filters, tube filters, filter presses, rotating filters, reversible-flow filters and multilayer filters.

From the pre-treatment of the cellulose, the cellulose suspension and the cellulose solution, as described above, finally an extrudable cellulose solution is obtained, which can be extruded in an extrusion head through one or more extrusion openings into an air gap and can be drawn in the air gap to form endless moulded bodies with preorientated polymer chains in the form of fibres, threads, films and membranes.

To produce the cellulose solution, the NMMNO is preferably fed in a shear zone, i.e. in a section in which shear stresses act on the cellulose suspension. In this way, a highly consistent slurry is generated which can be converted into the spinning solution in a following vaporisation stage. The cellulose concentration in the slurry is very high in this method step and may be more than 10%.

The shear zones can, for example, be formed in one or more stirring and conveying devices in which shear elements or conveying elements, such as paddles, screws, blades, act on the cellulose suspension.

In the following, an embodiment of the invention is described as an example with reference to the drawings. In this respect the features, as they are assigned to individual advantageous versions of the invention according to the above embodiments, can be combined with one another and can also be left out. In addition the invention is documented based on experimental examples.

In the following,

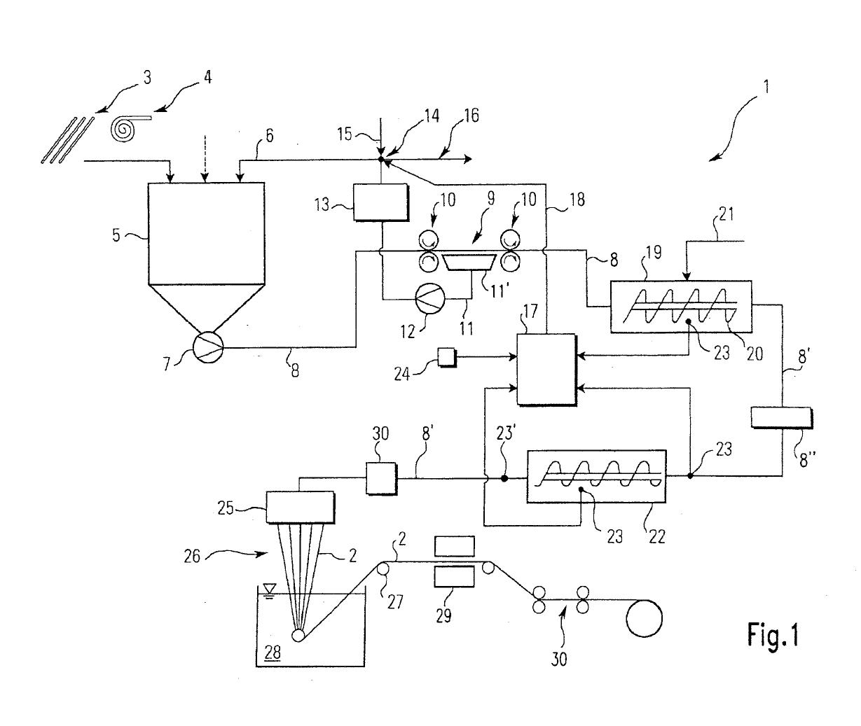

FIG. 1 shows an embodiment of a device according to the invention for the production of a cellulose solution in a schematic representation, whereby the method according to the invention can be implemented by the embodiment;

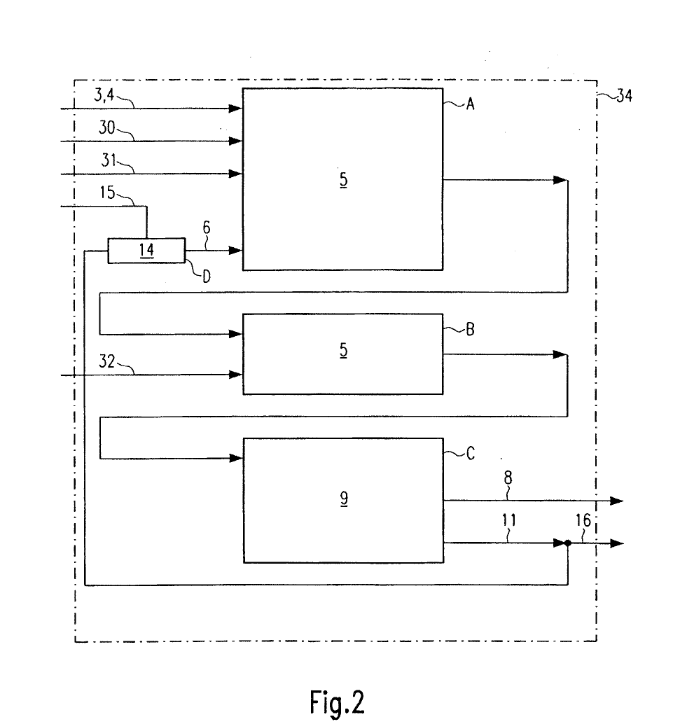

FIG. 2 shows a schematic representation of the process steps of the method for the production of the cellulose suspension;

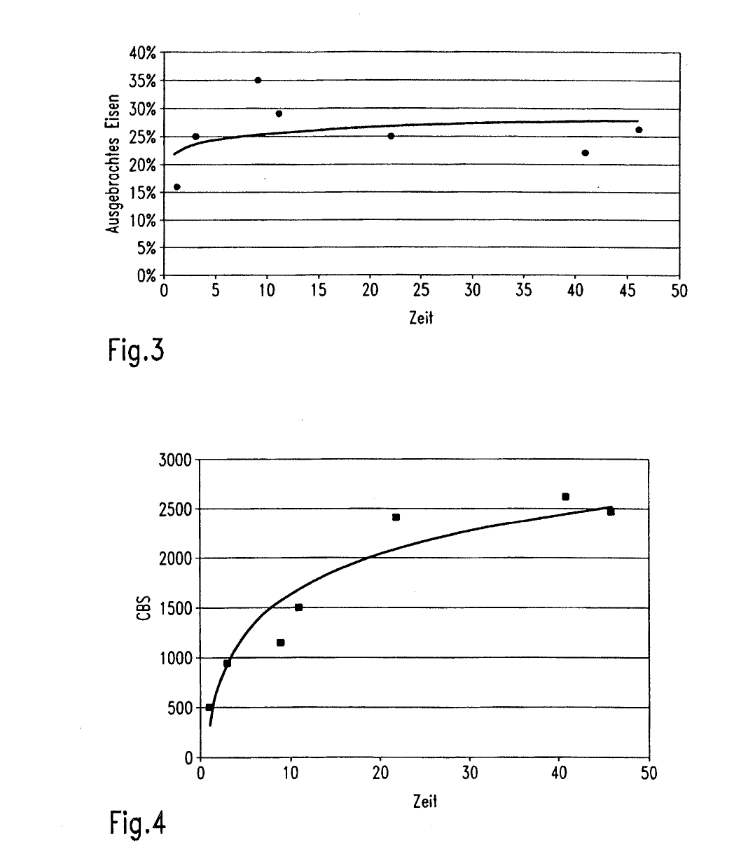

FIG. 3 shows a schematic representation of the variation of the amount of the iron ions removed against time;

FIG. 4 shows a schematic representation of the chemical oxygen demand in the press water against time;

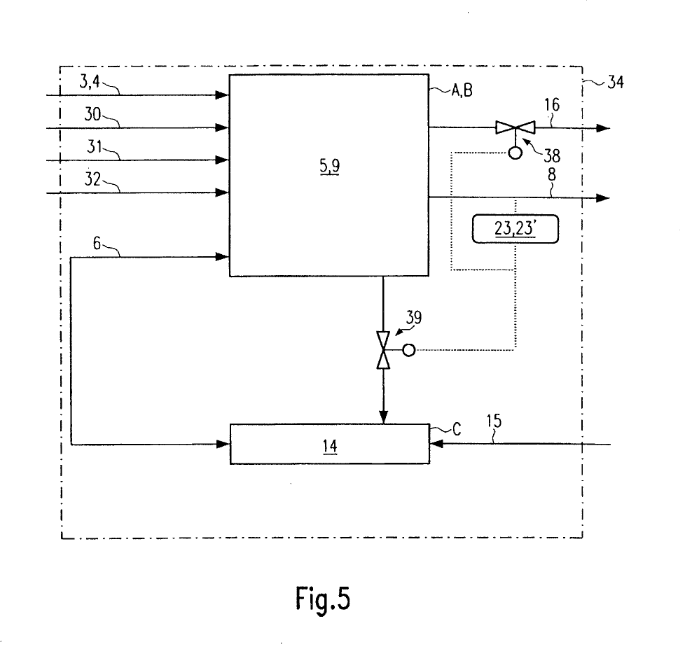

FIG. 5 shows a schematic representation of a method for controlling the press water feedback and the metal content.

FIG. 1 shows a plant 1 for the production of endless moulded bodies 2, for example filaments, of a spinnable cellulose solution containing water, cellulose and tertiary amine oxide.

First, cellulose in the form of leaves or plates 3 and/or rolls 4 is fed in batches to a pulper 5. In the pulper 5, the cellulose 3, 4 is disintegrated with water, symbolically represented by the arrow 6, and a cellulose suspension is formed, preferably still without solvent or amine oxide. Enzymes can be added for the homogenisation and stabilisation of the cellulose suspension.

The quantity of the water 6 added is determined depending on the water content of the cellulose. Typically, the water content of the cellulose used is between 5 and 15 percent by mass. This variation is compensated by changing the addition of water appropriately, so that the water content of the cellulose suspension or the slurry ratio of solids/liquid remains approximately constant or reaches a freely selected value.

The cellulose suspension is passed from the pulper 5 through a thick matter pump 7 via a pipe system 8 to a press device 9, whereby the cellulose suspension of water and cellulose is preferably maintained in a temperature range from 75 to 100° C.

In the press device, the cellulose suspension produced by the pulper 5 is expressed, for example, by rotating rolls 10. The expressed water or press water 11 is collected by a collecting device 11′ and returned to the pulper 5, at least as part of the water 6, by a conveying means 12, through an optional filter device 13 and through a mixing device 14. The press device 9 can also be fitted with a suction device (not shown) for sucking off the excess water from the cellulose suspension. In this embodiment, the sucked-off water is passed back, as the press water, at least in part to the pulper 5. For the purposes of this invention, sucked-off water or water removed from the cellulose suspension by other means is also press water which can be reused for the disintegration of the cellulose.

The filter 13 can comprise one or more surface filters, deep-bed filters, membrane filters, plate filters, edge filters, separators, centrifuges, hydrocyclones, belt filters and vacuum belt filters, tube filters, filter presses, rotating filters, reversible-flow filters and multilayer filters. In addition, the press water 11 can be osmotically treated in the filter 13; alternatively or additionally, metal ions and particles can be filtered out of the press water 11 or metal-binding additives can added to the press water 11.

The mixing device 14 adjusts the respective proportions of the press water 11 and the fresh water 15, fed from another fresh water source, in the water passed to the pulper 5. In addition, the proportion of the press water 11, which is passed out of the plant 1 through a waste water pipe, is controlled by the mixing device 14.

The mixing device 14 can comprise, for example, a selector valve or a number of valves. The mixing device 14 is controlled by a control device 17 such that the proportions of the press water 11 and the fresh water 15 in the water 6 fed to the pulper 5 can be set to variably preset values by an output signal from the control device via at least one control line 18.

After expressing, the cellulose suspension is transported further through the pipe system 8 to a stirring and conveying means 19 in which a shear stress acting on the cellulose suspension is generated by a stirring or conveying tool 20, such as screws, paddles or blades. For the stirring and conveying means 19, no annular layer mixers can be employed, such as originating from DRAIS Misch- und Reaktionssysteme and sold under the designation CoriMix®. The annular layer mixers are only used for moistening or impregnating dry cellulose materials which are not used in the method described here.

In the region of the shear stresses, in the so-called shear zone, a tertiary amine oxide, in particular N-methylmorpholine-N-oxide, is fed in aqueous form via a pipe 21 to the cellulose suspension with a molar ratio NMMNO/H₂O of between 1:1 and 1:2.5 as solvent for the cellulose. In addition, in the shear zone additives, such as stabilisers and enzymes, organic additives, delustering substances, alkalis, solid or liquid alkaline earths and/or dyes, can be added to the cellulose suspension.

The concentration of the NMMNO added depends on the water content of the celluloses 3, 4 currently in the cellulose suspension. The stirring and conveying means 19 acts as a mixer in which the tertiary amine oxide is mixed with the cellulose suspension and the cellulose solution is produced. Then the cellulose solution to which NMMNO has been added is transported via the pipe system 8 to a second stirring and conveying means 22. The stirring and conveying means 22 can comprise a vaporisation stage. Starting from the stirring and conveying means 22, the pipe system can be heated. In contrast to the unheated pipe system 8, the heated pipe system in FIG. 1 is given the reference symbol 8′. In particular, a pipe system can be used, as it is described in WO 01/88232 A1, WO 01/88419 A1 and WO 03/69200 A1.

After the addition of the tertiary amine oxide, the metal content of the cellulose solution in the pipe 8′ and/or in at least one of the shear zones 19, 22, or before and/or after one of the shear zones is measured using the sensors 23, 23′ and a signal representing the metal content or the content of individual metal ions, such as iron, chrome, copper and/or molybdenum ions, is output to the control device 17. Alternatively or in addition to an automatic inline sample extraction, in a further embodiment, the metal ion content can be first determined in an automatic laboratory analysis device using wet-chemical methods after manual sampling and then be passed on from there to the control device 17 automatically or manually. However, when comparing manual sampling to the automatic inline sample extraction directly from the pipe systems 8, 8′, there is the disadvantage that the feedback to control the metal ion content includes a manual process step and therefore cannot be automated.

The control device 17 compares the metal content measured by the sensors 23, 23′ with predetermined limiting values and outputs a signal depending on this metal content to the mixing device 14. Due to the control signal to the mixing device 14, the composition of the water 6 passed to the pulper 5 is adjusted depending on the metal content of the cellulose solution and the metal content or the content of individual metal ions in the cellulose solution to which tertiary amine oxide has been added is regulated under closed-loop control to a predetermined value. Since the concentration of reactions in the cellulose solution increases after the vaporisation stage, preferably, a sensor is provided which monitors the metal content of the cellulose solution after the addition of all constituents and after all the vaporisation stages.

If, for example, the metal content of the cellulose solution, as acquired by the sensors 23, 23′ or by using wet-chemical methods, is too high, then the proportion of fresh water in the water 6 fed to the pulper 5 is increased. Thereby, the metal content is adjusted by the control device 17 such that it remains below 20 mg/kg, preferably below 10 mg/kg and most preferably below 5 mg/kg. The metal content can also be determined before the formation of the cellulose solution, i.e. still in the cellulose suspension, whereby this measurement is more appropriate than the measurement of the metal content directly in the cellulose solution.

During the control of the composition of the water 6, the control device 17 takes the previously determined metal content of the cellulose 3, 4 passed to the pulper 5 into account. In this respect, the analysed metal content of individual metal ions or the overall content of metal in the cellulose 3, 4 just used can be entered into the control device 17 via an input device 24. This preadjustment is taken into account in order to determine the proportions of the press water and fresh water in the water fed to the pulper 5. For example, when using celluloses with a high metal content, a higher proportion of fresh water 15 is fed to the pulper 5 at the start or certain metal-binding additives are mixed into the cellulose suspension.

If the metal content, as it is acquired by the sensors 23, 23′, in the cellulose solution to which tertiary amine oxide has been added, decreases below a certain limit which is taken as sufficient for protection against exothermic reactions, for example 10 mg/kg, then the portion of press water in the water passed to the pulper 5 is increased. Consequently, less fresh water is consumed and less press water is discharged to the environment, while achieving an adequate protection against exothermic reactions.

After the stirring and conveying means 22, the now extrudable cellulose solution is passed to an extrusion head 25 which is provided with a large number of extrusion openings (not shown). The highly viscous cellulose solution is extruded through each of these extrusion openings into an air gap 26 to give in each case an endless moulded body 2. An orientation of the cellulose molecules occurs due to an extension of the cellulose solution which is still viscous after the extrusion. To achieve this, the extruded cellulose solution is pulled away from the extrusion openings at a speed which is greater than the extrusion speed by a draw-off mechanism 27.

After the air gap 26, the endless moulded bodies 2 traverse a precipitation bath 28 containing a non-solvent, such as water, whereby the cellulose in the endless moulded bodies 2 is precipitated. In the air gap 26, the endless moulded bodies 2 are cooled by a cooling gas flow 26′. Here, in contrast to the theory disclosed in WO 93/19230 A1 and EP 584 318 B1, it has been found substantially more advantageous if the cooling gas flow is not applied directly after the endless moulded bodies 2 emerge from the nozzle, but rather is applied to the endless moulded bodies 2 at a distance from the nozzle. In order to achieve the best fibre properties, the cooling gas flow should be turbulent and exhibit a velocity component in the extrusion direction, as described in WO 03/57951 A1 and in WO 03/57952 A1.

Then the endless moulded bodies are treated further, for example washed, brightened, chemically treated, in a device 28 to influence the cross-linking properties, and/or dried and pressed out further in a device 29. The endless moulded bodies can also be processed by a cutting device, which is not shown, to form staple fibres and be passed out of the device 1 in fleece form.

The overall conveyance of the cellulose solution in the pipe system 8′ occurs continuously, whereby buffer containers 30 can be provided in the pipe system 8′ to compensate variations in the conveyed amount and/or of the conveying pressure and to facilitate a continuous processing without dead water regions arising. The pipe system 8′ is equipped with a heating system (not shown) to maintain the cellulose solution during conveyance at a temperature at which decomposition of the tertiary amine oxide is avoided and the viscosity is adequately low for an economical transport. The temperature of the cellulose solution in the pipe section 8′ is here between 75 and 110° C.

At the same time, the homogenisation and uniform mixing, which can be increased by static or rotating mixers, is promoted by the high temperature.

The residence time of the cellulose suspension or solution in the pipe system 8, 8′ from the thick matter pump 7 to the extrusion head 25 is between 5 minutes and 2 hours, preferably about 30 to 60 minutes.

The implementation of the method according to the invention is now described based on experimental tests.

In the following, values are used for the quantity values which have been scaled to the amount of the introduced cellulose.

A first series of experiments involves cellulose pretreatment for the production of the cellulose suspension and the examination of the press water. In the following, reference is made to the schematic representation of the pretreatment in FIG. 2, and furthermore the reference symbols of FIG. 1 are used.

Experimental Test 1

In a process step A, cellulose 3, 4 (cf. FIG. 1) of the type MoDo Dissolving Wood Pulp, pine sulphite wood pulp, was placed in a pulper 5 from the company Grubbens with a net filling volume of 2 m³ with water 6 in a mixing ratio of 1:17 (solids density 5.5%). The cellulose showed a cuoxam dp of 650 and an α-cellulose content >95%. Other possible celluloses are Sappi Eucalyptus, Bacell Eucalyptus, Tembec Temfilm H W, Alicell V L V and Weyerhäuser a-cellulose of <95%. The water 6 fed consisted of 30 parts of fully desalinated fresh water 15 and 70 parts of press water.

Under vigorous stirring, technically pure formic acid 30 in the ratio of 1:140 and a liquid enzyme preparation 31 in the ratio 200:1, referred in each case to the cellulose content, were added. An enzymatic pretreatment was then carried out for a duration of about 35 minutes until a homogeneous cellulose suspension was obtained. A cellulase enzyme complex, such as for example Celluprack® AL 70 from Bioprack GmbH or Cellusoft from Novo Nordisk can be used as the enzyme preparation 31.

Then, the pretreatment was terminated in a process step B by the addition of sodium hydroxide solution 32 in the ratio of 1:500 referred to the cellulose content of the cellulose suspension in the pulper 5.

The cellulose suspension was then dehydratised to about 50% in a process step C in a vacuum belt filter acting as press device 9 and a following expressing system from the company Pannevis, so that the expressed cellulose showed a dry content of about 50%. From step C, the expressed cellulose was then passed on via the pipe 8 for the production of a cellulose solution containing NMMNO, water and cellulose. These steps are not shown in FIG. 2 for the sake of simplicity.

The press water was collected in the press means 9 and led away via the pipe 11 (cf. FIG. 1). Approximately 75% of the press water was fed back to the pulper 5 and about 25% of the press water was passed to a waste water purifier via the pipe 16.

The degree of polymerisation of the cellulose was always selected such that a dp (degree of polymerisation) of about 450 to about 550 was obtained in the spinning solution. The cellulose concentration was set to about 12% in the spinning solution.

The press water remaining in the system 34 was mixed in a mixing device 14 (cf. FIG. 1) with the fully desalinated water in a process step D, as described above.

Experimental Test 2

In another experiment all the steps of Experimental Test 1 were repeated, except that in process step A the quantity of the added enzyme preparation was reduced to 125:1 referred to the cellulose content of the cellulose suspension.

Experimental Test 3

In another experiment the steps of Experimental Tests 1 and 2 were repeated, except that in process step A no enzyme preparation was added.

Results of the Experimental Tests 1 to 3

To check the effectiveness of the method according to the invention, the copper and iron ion content of the press water collected during the expressing stage was analysed and additionally the chemical oxygen demand was determined.

As a result of this experiment, it can be recorded that during the first pulp cycles the values, that are acquired for the substances contained, increase due to the circulation of part of the press water. However, since part of the press water with the dissolved content substances is permanently removed, a steady state is reached after some time in which the amount of substances contained, in particular the metal ions, remains constant.

Overall, about 10% of the iron ions introduced by the cellulose 3, 4 and about 40% of the copper ions introduced by the cellulose was removed by the press water feedback. In continuous plant operation, due to the return of the press water, the percentage of iron extracted from the system 34 may be between 22% and 35% referred to the quantity of iron introduced by the cellulose.

FIG. 3 gives a schematic progression of the iron ion extraction over time.

The stable final state of the system 34 is achieved, as Experimental Tests 1 to 3 show, independent of the amount of enzymes introduced for the pretreatment of the cellulose.

This is also confirmed by the change of the chemical oxygen demand (COD) over time, as illustrated in FIG. 4. The chemical oxygen demand was determined in the press water according to DIN 38409 and approximates with increasing duration of the press water feedback to a constant value.

Furthermore, the degree of polymerisation, and therefrom the dp reduction as well as the onset temperature of the spinning solution were determined as indicators of stability in the cellulose solutions obtained according to Experimental Tests 1 to 3. The results of the experiments are shown in Table 1.

TABLE 1

| Experimental | DP reduction | Tₒₙₛₑₜ |
|---|---|---|
| Test | [%] | ° C. |
| 1 | 9 | 160 |
| 2 | 27 | 165 |
| 3 | 27.5 | 165 |

As shown in Table 1, the cellulose solution obtained through press water feedback is stable and exhibits an onset temperature of at least 160° C. This onset temperature is substantially higher than the onset temperature which is for example obtained with pulping in N-oxide directly onto a 12% cellulose solution. According to experiments, with this method an onset temperature of at the most 147° C. is actually obtained. The onset temperature according to Table 1 using the method according to the invention with press water feedback also lies above the onset temperature as obtained with the method of WO 95/08010 and which in practice is about 150° C.

Based on these investigations, it can be seen that, despite the press water feedback, the onset temperatures still lie above the onset temperatures for the dry processing of cellulose and can be increased by an enzymatic pretreatment of the cellulose. This means that the press water feedback is suitable for industrial use.

In another series of experiments, the effect of the substances contained in the press water on the stability of the cellulose solution was investigated. To achieve this, in each of the Experimental Tests 1 and 3, a concentrate of 5 l of press water was added in the ratio 1:270 to the cellulose solution and feedback of the press water was omitted.

In both cases, once according to the method of Experiment 1 without enzymatic pretreatment and once according to the method of Experiment 3 with enzymatic pretreatment, a reduction of the onset temperature to about 141° C. occurred in each case due to the press water concentrate. Thus, it is demonstrated that the press water fundamentally reduces the stability of the cellulose solution. This destabilisation of the cellulose solution can however be avoided by the press water feedback. The proportion of the press water fed back depends on the type of cellulose used.

The iron and copper content as well as the overall metal ion content of the cellulose varied noticeably with the various types of cellulose, as can be seen from Table 2. The metal content of the various types of cellulose was determined by incineration in a platinum pan according to DIN EN ISO 11885 (E22) and with flame AAS. With the method according to the invention, the proportion of the press water fed back is adjusted depending on the type of cellulose, for example according to the manufacturer's specification on the metal content.

TABLE 2
Used cellulose

| Substances | | | | | | | | |
|---|---|---|---|---|---|---|---|---|
| contained | Cellulose | Cellulose | Cellulose | Cellulose | Cellulose | Cellulose | Cellulose | Cellulose |
| in cellulose | 1 mg/kg | 2 mg/kg | 3 mg/kg | 4 mg/kg | 5 mg/kg | 6 mg/kg | 7 mg/kg | 8 mg/kg |
| Fe | 1.3 | 2.0 | 1.6 | 5.8 | 2.2 | 2.6 | 14 | 13 |
| Mn | <0.3 | <0.1 | 0.2 | 0.33 | n.d. | <0.3 | 0.4 | <0.3 |
| Mg | 2 | 2 | 226 | 32 | 138 | 2 | 21 | 7.8 |
| Co | 0.3 | <0.3 | <0.3 | <0.3 | <0.3 | <0.3 | <0.3 | <0.3 |
| Ca | 54 | 4 | 37 | 64 | 30 | 6 | 130 | 27 |
| Cr | <0.3 | <0.3 | 1.4 | <0.3 | <0.3 | 0.4 | <0.3 | <0.3 |
| Mo | <0.3 | <0.1 | <0.1 | <0.1 | <0.3 | <0.3 | <0.3 | <0.3 |
| Ni | <0.3 | <0.3 | <0.3 | <0.3 | <0.3 | <0.3 | <0.3 | <0.3 |
| Cu | 0.3 | <0.2 | 0.2 | <0.3 | <0.3 | <0.3 | 0.3 | 0.3 |
| Na | 396 | 48 | 93 | 92 | 263 | 176 | 335 | 8.2 |

In a final series of experiments, the schematic experimental set-up of FIG. 5 was used. In FIG. 5, the reference symbols of FIGS. 1 and 2 are used for elements with similar or the same function.

With the set-up in FIG. 5, the amount of press water returned to the pulper 5 was adjusted to the iron and copper content of the expressed cellulose.

With the arrangement of FIG. 5, the iron ion and copper ion content was measured as representative values for the metal ion content by the sensors 23, 23′ (cf. FIG. 1).

Due to the control of the portion of the press water in the water 6 fed to the pulper 5, the iron concentration was maintained as closely as possible below 10 mg/kg absolutely dry and the copper concentration just below 0.2 mg/kg absolutely dry. These values were possible for an adequate stability of the cellulose solution in the pipe 8 with simultaneous maximum retention of the press water within the system 34 and consequently with minimum outward transfer of the press water 16 from the system 34.

The control of the metal ion content occurred in such a way that, if one of these two limits was exceeded, the amount of press water outwardly transferred from the system 34 and passed on for waste water purification was increased by opening a valve 38. At the same time, closure of the valve 39 reduced the proportion of press water fed back in the pretreatment stage.

1. A method of producing a cellulose solution, from which endless molded bodies can be extruded, the method comprising firstly producing a cellulose suspension from cellulose and water, the suspension being expressed with the production of press water, and then producing the cellulose solution from the cellulose suspension by the addition of tertiary amine oxide, wherein the press water is fed back for treating the cellulose and fresh water is admixed to the fed back press water, the proportions of press water and fresh water being varied depending on the metal ion content of the type of cellulose.

2. The method according to claim 1, wherein the fresh water is at least partially desalinated.

3. The method according to claim 1, wherein the metal content of the cellulose suspension, the cellulose solution or combination thereof is set below a certain maximum value by changing the proportion of fresh water, press water or combination thereof in the water for treating the cellulose.

4. The method according to claim 3, wherein the metal content is set to below 20 mg/kg.

5. The method according to claim 4, wherein the metal content of the cellulose solution is set to below 10 mg/kg.

6. The method according to claim 5, wherein the metal content of the cellulose solution is set to below 5 mg/kg.

7. The method according to claim 1, wherein the cellulose suspension is initially essentially produced without the addition of a solvent.

8. The method according to claim 1, wherein metal-binding additives are added when treating the cellulose.

9. The method according to claim 1, wherein stabilizers are added when treating the cellulose.

10. The method according to claim 1, wherein enzymes are added when treating the cellulose.

11. The method according to claim 1, wherein the water for treating the cellulose contains between 50% and 100% press water.

12. The method according to claim 1, wherein the content of metal ions in the cellulose solution is monitored.

13. The method according to claim 12, wherein the content of copper, iron, molybdenum ions or combination thereof in the cellulose solution is monitored.

14. The method according to claim 12, wherein the content of metal ions is determined on a sample manually extracted from the cellulose solution, cellulose suspension or combination thereof.

15. The method according to claim 12, wherein the metal ion content is determined automatically by an inline analysis.

16. The method according to claim 1, wherein the composition of the water used for the treatment is changed depending on the measured content of metal ions in the cellulose solution, cellulose suspension or combination thereof.

17. The method according to claim 1, wherein N-methylmorpholine-N-oxide is fed to the expressed cellulose suspension.

18. The method according to claim 17, wherein the concentration of the tertiary amine oxide in the cellulose solution is changed in dependence of the water content of the expressed cellulose.

19. The method according to claim 1, wherein the press water is filtered before treating the cellulose.

20. The method according to claim 1, wherein the press water is treated osmotically before treating the cellulose.

21. The method according to claim 1, wherein the cellulose solution is extruded to give at least one endless body.

22. A device for the production of a cellulose solution, from which endless bodies can be produced, comprising
a pulper, in which in operation cellulose and water can be mixed to give a cellulose solution;
a press device, through which the water can in operation be expressed from the cellulose solution in the form of press water;
a mixer, through which in operation tertiary amine oxide can be admixed to the cellulose suspension to form a cellulose solution;
a press water line, through which in operation at least one part of the press water can be fed back to the pulper from the press device; and
a mixing device, through which the proportion of the press water in the water fed back to the pulper can be variably set depending on the metal ion content of the type of cellulose.

23. The device according to claim 22, further comprising a waste water pipe, through which in operation part of the press water can be passed out of the device.

24. The device according to claim 22, further comprising at least one sensor, by which the content of at least one type of metal ion in the cellulose solution can be determined.

25. The device according to claim 24, wherein the sensor is part of an automatic laboratory analysis device, which can be charged with a sample after manual sample extraction from the pipe system.

26. The device according to claim 24, wherein the sensor is part of an inline analysis system, through which the metal ion content in the pipe system can be determined essentially automatically during operation.

27. The device according to claim 22, further comprising a control device, through which the composition of the water passed to the pulper can be varied in operation in dependence of a metal content of the cellulose, the cellulose solution or combination thereof.

28. The method of claim 7, wherein the cellulose suspension is initially essentially produced without the addition of a tertiary amine.
